(19) United States
(12) Patent Application Publication
(10) Pub. No.: US 2024/0343610 A1
(43) Pub. Date: Oct. 17, 2024

(54) GAS DEHYDRATION WATER MANAGEMENT SYSTEM AND PROCESS

(71) Applicant: SAUDI ARABIAN OIL COMPANY, Dhahran (SA)

(72) Inventors: Ali M. GHAMDI, Dhahran (SA); Mishar Kumar PAUL, Udhailiyah (SA); Yaser E. THEYABI, Dhahran (SA); Ali S. QAHTANI, Dammam (SA); Salman Z. FAHID, Dhahran (SA)

(73) Assignee: SAUDI ARABIAN OIL COMPANY, Dhahran (SA)

(21) Appl. No.: 18/299,774

(22) Filed: Apr. 13, 2023

(51) Int. Cl. C02F 1/04; B01D 1/28; C02F 1/00; C02F 1/20

(52) U.S. Cl. CPC C02F 1/041; B01D 1/2881; C02F 1/008; C02F 1/20; C02F 2101/101; C02F 2101/32; C02F 2103/18; C02F 2201/005; C02F 2209/03; C02F 2209/40; C02F 2209/42; C02F 2301/066

(57) ABSTRACT

A wastewater processing system includes a compressor arranged to receive and compress wastewater vapor into a compressed wastewater, an overhead separator that receives the compressed wastewater from the compressor and separates the compresses wastewater into bottom liquid wastewater and a vapor fraction, at least one of a condensate sphere and a sour water stripper, each in fluid communication with the overhead separator, wherein the sour water stripper receives the bottom liquid wastewater from the overhead separator to receive a portion of the bottom liquid wastewater, and an overhead separator level control system interposing the overhead separator and the at least one of the condensate sphere and the sour water stripper, the overhead separator level control system being configured to control a flow of the bottom liquid wastewater from the overhead separator to the sour water stripper and maintain a system pressure.

### FIELD OF THE DISCLOSURE

The present disclosure relates generally to systems and processes for dehydrating gases and, more particularly, to low pressure systems for processing wastewater vapor from a glycol regeneration system.

### BACKGROUND OF THE DISCLOSURE

A wet gas, such a natural gas produced from underground reservoirs, is typically saturated with water. Prior to being used, much of the water vapor must be removed from the wet gas. To accomplish this task, wet gases are processed through gas dehydration systems. A common type of gas dehydration system is a glycol dehydration system, which passes gas through a glycol contact tower, wherein wet gas contacts one or more glycols, such as blends that include triethylene glycol (“TEG”), which absorbs water from the gas. The result of this process is a dry gas and a water saturated glycol, which is also known as “rich glycol”. To reuse the saturated glycol, it is sent to a glycol regeneration system that removes the water prior to reintroducing the lean glycol back to the glycol tower to continue the gas dehydration process.

Glycol regeneration systems will typically include a glycol reboiler with a glycol condenser. To remove wastewater from the glycol, the wet glycol is passed through the glycol condenser and glycol reboiler, which results in wastewater absorbed in the glycol from the wet gas escaping the condenser as wastewater vapor. The wastewater vapor may include hydrocarbon contaminants as well as other contaminants that must be removed prior to the water being used in other processes or disposed of. These contaminants are typically removed with a sour water stripper or are collected in a condensate sphere. The wastewater vapor that exits glycol condenser will typically be at an elevated temperature (e.g., greater than 200° F.) and pressure (e.g., about 1 ATM) that are not conducive to the operation of the sour water stripper or liquid surge sphere. Accordingly, typical wastewater processing systems utilized with glycol-based gas dehydration systems will include heat exchangers to remove the excess heat and multiple compressors to raise the pressure of the wastewater.

Liquid pumps in conventional gas plant glycol regeneration systems frequently fail due to the severe operating environment and, more particularly, due to the recurrent changes of overhead separator levels, which can result in a severe impact on the seal and ring flow of certain types of compressors used glycol regeneration systems. This can lead to frequent startup and shutdown processes, which can damage pump internals and result in operation upsets, thereby increasing plant maintenance and wasting water by dumping the liquid to waste blowdown. This can also adversely affect equipment and piping reliability.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a wastewater processing system may include a compressor arranged to receive and compress wastewater vapor into a compressed wastewater, an overhead separator that receives the compressed wastewater from the compressor and separates the compresses wastewater into bottom liquid wastewater and a vapor fraction, at least one of a condensate sphere and a sour water stripper, each in fluid communication with the overhead separator, wherein the sour water stripper is configured to receive a portion of the bottom liquid wastewater, and an overhead separator level control system interposing the overhead separator and the at least one of the condensate sphere and the sour water stripper, the overhead separator level control system being configured to control a flow of the bottom liquid wastewater from the overhead separator to the sour water stripper and maintain a system pressure.

In another embodiment, a method may include compressing wastewater vapor with a compressor and thereby providing a compressed wastewater, receiving the compressed wastewater in an overhead separator, separating the compressed wastewater in the overhead separator into a bottom liquid wastewater and a vapor fraction, maintaining a level of bottom liquid wastewater in the overhead separator between a low-level operating capacity and a high-level operating capacity using an overhead separator level control system and stripping contaminants from the bottom liquid wastewater in a sour water stripper.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic illustration of a prior art waste water recovery system;

FIG. 2 is a schematic illustration of a gas drying system in accordance with embodiments of the disclosure;

FIG. 3 is a flow chart of a method of operating of the gas drying system in accordance with embodiments of the disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to systems and processes for dehydrating gases and, more particularly, to systems and processes for processing wastewater vapor from a glycol-based gas dehydration system. The gas processing systems described herein may be configured to send overhead separator liquids to a low-pressure system with pressures suitable for a NASH compressor outlet. This may prove advantageous in allowing the process to remove waste liquid pumps from the system by connecting a new line associated with a level control valve (LCV). The LCV may include proper instrumentation and control operable to efficiently control the overhead separator level without any impact on operations. The overhead separator liquid will be diverted from the header piping through a connecting line to an HC recovery drum, which sends it back to a condensate sphere through a pump.

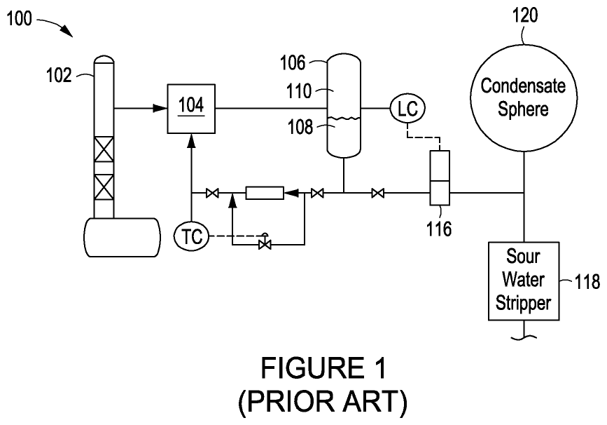

FIG. 1 is a schematic illustration of a prior art wastewater recovery system 100. As illustrated, the wastewater recovery system 100 includes a glycol condenser 102, and water vapor escaping the glycol condenser 102 passes through a first compressor 104, such as a liquid ring compressor available from Nash. The first compressor 104 is operable to raise the pressure of the water vapor to around 50 psig. The compressed wastewater then passes to an overhead separator 106 operable to receive and separate the wastewater into a bottom liquid 108, which mostly contains water, and a vapor fraction 110, which mostly contains hydrocarbon contaminants from the water.

Most of the bottom liquid 108 that flows out of the separator 106 (about 46 gallons per minute or “gpm”) is returned back to the compressor 104 for maintaining the seal, ring flow, and discharge pressure of the first compressor 104. The remaining bottom liquid 108, about 2 gpm, is conveyed to a second compressor 116, such as high-pressure liquid ring compressor available from Nash, where it is pressurized to about 100 psig and is then channeled through the header piping of the dehydration system 100 to a sour water stripper 118 or a liquid surge sphere 120 (alternately referred to as a “condensate” sphere).

During operation of the wastewater recovery system 100, the second compressor 116 is typically subject to severe operating conditions that results in frequent failures. Specifically, the recurrent changes in the wastewater levels in the overhead separator 106 result in severe impact on the seal and ring flow of the second compressor 116. Subsequently, frequent start and shutdown processes of the second compressor 116 results in damage to the internal components of the compressor 116, which can lead to frequent compressor failure. When the second compressor 116 fails, this can result in significant plant disruption. Shutting down the second compressor 116 can also adversely affect and impact other equipment and piping reliability within the wastewater recovery system 100. It may be advantageous to have a wastewater recovery system that does not require the second compressor 116, which could improve facility operations, decrease facility downtime, and increase wastewater recovery.

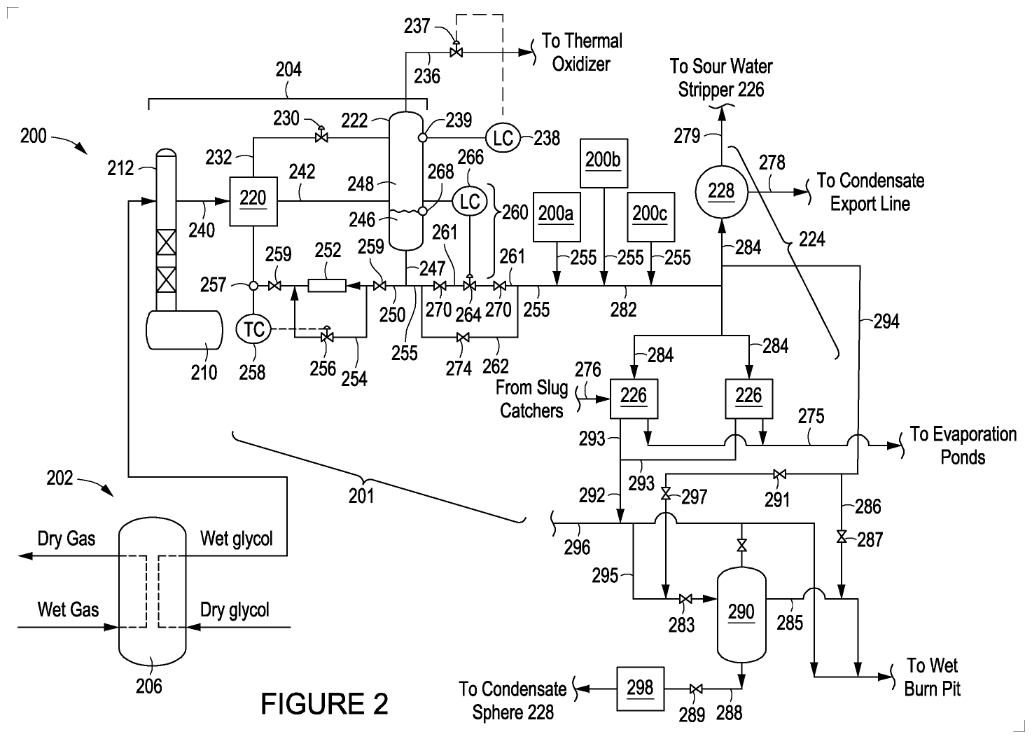

FIG. 2 is a schematic illustration of an example gas drying system 200 with an improved wastewater processing system 201, in accordance with embodiments of the invention. The wastewater processing system 201 may be similar in some respects to the wastewater recovery system 100 of FIG. 1 and, therefore, may be best understood with reference thereto. A facility that processes wet gases, such as saturated natural gas from a well, may include one or more gas drying systems 200. In the illustrated embodiment, the gas drying system 200 includes a glycol-based gas dehydration system 202 and a glycol regeneration system 204.

In the glycol-based gas dehydration system 202, a wet gas is brought into contact with one or more dry glycols conveyed to and present within an absorber 206, alternately referred to as a “glycol contactor”. The glycol(s) in the absorber 206 may help remove water from the wet gas by physical absorption, resulting in a dehydrated or “dry” gas and a wet glycol. The dry gas exiting the glycol contactor 206 can, for example, be flowed to a pipeline or other facility for further processing or storage.

The wet glycol exiting the glycol contactor 206, alternately referred to as a “rich” glycol, can be regenerated in the glycol regeneration system 204, which is operable to remove the water from the rich glycol, so that the glycol can be recycled and re-used in the glycol contactor 206 as “dry” glycol. As illustrated, the glycol regeneration system 204 may include a glycol reboiler 210, a glycol condenser 212 and a wastewater processing system 201.

Glycol reboilers 210 and glycol condensers 212 are known in the art. In an exemplary embodiment, the rich glycol discharged from the glycol contactor 206 may be fed into the glycol condenser 212 and the glycol reboiler 210 where the rich glycol is heated, and the wastewater absorbed into the glycol from the wet gas boils off as wastewater vapor. The wastewater vapor exits the glycol condenser 212 and is conveyed to the wastewater processing system 201 via a conduit or piping 240 for processing to remove hydrocarbons and other contaminants, such as hydrogen sulfide and carbon dioxide.

As illustrated, the wastewater processing system 201 may include a compressor 220, an overhead separator 222, and one or more downstream systems 224 for processing the wastewater and hydrocarbon vapors. In at least one embodiment, the downstream system(s) 224 may include a sour water stripper 226 and a condensate sphere (alternately referred to as a “liquid surge” sphere). Suitable conduits or piping 250 may convey a portion of the wastewater (e.g., bottom liquid 246) from the overhead separator 222 back to the compressor 220, and suitable conduits such as wastewater header 255 may convey the remaining portion of the wastewater from the overhead separator 222 to the downstream system(s) 224.

After leaving the glycol condenser 212 and entering the wastewater processing system 201, the wastewater vapor may be at about atmospheric pressure and at an elevated temperature. In some embodiments, however, the wastewater vapor may be at a pressure less than atmospheric pressure. In some embodiments, the operating pressure may be in a range between about 0.1 psig and about 3 psig. In an embodiment, the elevated temperature of the wastewater vapor may be in a range from about 200° F. to about 220° F.

In some embodiments, the wastewater vapor discharged from the glycol condenser 212 may be conveyed through a heat exchanger to exchange heat with the glycol passing through the glycol condenser 212. The wastewater vapor is then received by and compressed in the compressor 220. In some embodiments, the compressor 220 may be the same as or similar to the first compressor 104 (FIG. 1), such as a liquid ring compressor, such as Nash model 1256. In some embodiments, the compressor 220 receives a recycled flow of wastewater to maintain a constant flow rate to the compressor 220, which is discussed in greater detail below. In some embodiments, a vapor recycle valve 230 may be arranged in a conduit 232 extending between the overhead separator 222 and the compressor 220. The vapor recycle valve 230 may be operable to control the suction pressure of the compressor 220. The compressor 220 may be operable to compress the wastewater vapor to a pressure sufficient allow the wastewater to be processed in the downstream system(s) 224. The act of compressing the wastewater vapor and contact with the relatively cool liquid ring serves to condense wastewater vapor. In some embodiments, the suction pressure of the compressor 220 may be in a range from about 0.1 psig to about 3 psig and the suction temperature may be in a range from about 200° F. to about 220° F. In one or more embodiments, for example, the compressor 220 may compress the wastewater vapor to a pressure ranging between about 40 psig and about 60 psig. In another embodiment, the compressor 220 may compress the wastewater vapor to a pressure ranging between about 45 psig and about 55 psig. In yet other embodiments, the compressor 220 may compresses the wastewater vapor to a pressure of about 50 psig. Further, in some embodiments, the discharge temperature may be in a range from about 215° F. to about 225° F. or about 220° F. In some embodiments, the flow rate of the discharge from the compressor 220 may be in a range from about 0.4 million standard cubic feet per day (MMSCFD) to about 0.7 MMSCFD.

The compressed wastewater is then conveyed to the overhead separator 222 via the piping 242. In an embodiment, the piping 240 extending between the glycol condenser 212 and the compressor 220 may exhibit a diameter of about 6 inches. In an embodiment, the piping 242 extending between the compressor 220 and the overhead separator 222 may exhibit a diameter of about 4 inches and is configured to carry compressed wastewater at the elevated pressures produced by the compressor 220.

In the overhead separator 222, the incoming wastewater is separated into a bottom liquid 246, which mostly contains wastewater, and a vapor fraction 248, which mostly contains hydrocarbons and other vaporized contaminants derived from the wastewater. In an exemplary embodiment, the overhead separator 222 has a height that is approximately double its diameter, such as a height of about 10 feet and a diameter of about 5 feet. The overhead separator 222 is configured to operate under the pressurized conditions created by the compressor 220. The vapor fraction 248 may exit the overhead separator 222 via conduit 236, passing through pressure control valve 237 to a thermal oxidizer (not shown). The pressure control valve 237 may be controlled by a pressure control valve controller 238 that receives data from a pressure sensor 239 regarding pressure in the overhead separator. Wastewater forming the bottom liquid 246 may exit the overhead separator 222 via piping 247. In at least one embodiment, piping 247 exhibits a diameter of about three inches.

The volume of the bottom liquid 246 wastewater in the overhead separator 222 may vary based on the flow of compressed wastewater into the overhead separator 222 and the flow of the bottom liquid 246 discharged from the overhead separator 222 via the piping 247. In an embodiment, the overhead separator 222 may have a low-level operating capacity in a range from about 25% total volume to about 35% total volume. In another embodiment, the low-level operating capacity may be in a range from about 30% total volume to about 35% total volume. In another embodiment, the low-level operating capacity is about 32%. In an embodiment, the high-level operating capacity is in a range from about 70% of the total volume to about 90% of the total volume. In another embodiment, the high-level operating capacity is in a range from about 75% of the total volume to about 85% of the total volume. In another embodiment, the high-level operating capacity is about 80%.

In an embodiment, a majority portion of the bottom liquid 246 wastewater that flows out of the overhead separator 222 may be recycled back to the compressor 220 via the piping 250 and used to help maintain the seal, ring flow, and suction pressure of the compressor 220. In contrast, a minority portion of the bottom liquid 246 wastewater may be conveyed to the downstream system(s) 224 via the wastewater header 255 for further processing. In an embodiment, the bottom liquid 246 wastewater flows out of the overhead separator 222 at a rate of between 45 gallons per minute (“gpm”) and 50 gpm, and in another embodiment the flow rate is about 48 gpm. In an embodiment, the flow rate of the majority portion in the piping 250 is in a range from about 90% to about 97% of the total flow rate of the bottom liquid 246 wastewater flowing out of the overhead separator 222. In another embodiment, the flow rate of the majority portion in the piping 250 is about 96% of the total flow rate of the bottom liquid 246 wastewater flowing out of the overhead separator 222. In another embodiment, the flow rate of the majority portion in the piping 250 is in a range from about 40 gpm to about 49 gpm, and in another embodiment the flow rate of the majority portion in the piping 250 is about 48 gpm. The minority portion in the wastewater header 255 will be the remaining portion of the bottom liquid 246 wastewater flowing out of the overhead separator 222 that is not in the majority portion. In an embodiment, the flow rate of the minority portion in the piping 255 is in a range from about 1 gpm to about 5 gpm, and in another embodiment the flow rate of the minority portion in the piping 255 is about 2 gpm.

The majority portion of the bottom liquid 246 wastewater flowing out of the overhead separator 222 may pass through piping 250 to an air cooler 252 or a bypass line 254 prior to reaching the compressor 220. The bypass line 254 may have a temperature control valve 256, a temperature controller 258, and associated instrumentation 257 (e.g., temperature sensors) providing real-time temperature data to the temperature controller 258. The temperature controller 258 may be operable to control the open and closed state of the temperature control valve 256 based on the data obtained by the instrumentation 257. The piping 250 may also include one or more valves 259 arranged before and after the air cooler 252 and bypass line 254. In an embodiment, the piping 250 for the majority portion of the bottom liquid 246 may exhibit a diameter of about 2 inches.

The minority portion of the bottom liquid 246 wastewater flowing out of the overhead separator 222 is conveyed through piping 255 to an overhead separator level control system 260 before flowing to the downstream system(s) 224 via header piping 282. In some applications, and as needed, the minority portion may also be directed through a bypass line 262. As illustrated, the overhead separator level control system 260 may include a level control valve 264, a level control valve controller 266 (“LCV controller”), and instrumentation 268 that acquires data about the level of the bottom liquid 246 in the overhead separator 222. Based on the data obtained by the instrumentation 268, such as the detected level of the bottom liquid 246 in the overhead separator 222, the LCV controller 266 may be configured to control the open and closed state of the level control valve 264.

During normal operation, the impact of pressure on the level of bottom liquid 246 wastewater may not be significant, and the level control valve 264 may be partially opened. The level control valve 264 may be fully opened if the level of bottom liquid 246 wastewater increases above the a normal level set point due to a high volume of compressed wastewater entering into the overhead separator 222 from the compressor 220. In contrast, the level control valve 264 may be completely closed if the level of bottom liquid wastewater in the overhead separator 222 is below a normal level set point. In some embodiments, the normal level set point may be in a range from about 28% of the total volume of the overhead separator 222 to about 45% of the total volume of the overhead separator 222. In other embodiments, the normal level set point may be in a range from about 35% of the total volume of the overhead separator 222 to about 50% of the total volume of the overhead separator 222. In other embodiments, the normal level set point may be in a range from about 40% of the total volume of the overhead separator 222 to about 55% of the total volume of the overhead separator 222. In other embodiments, the normal level set point may be in a range from about 28% of the total volume of the overhead separator 222 to about 55% of the total volume of the overhead separator 222.

The piping 261 on either side of the overhead separator level control system 260 may include valves 270 operable to isolate the system 260, if needed. The bypass line 262 may also include one or more valves 274 (one shown) to control the flow of wastewater through the bypass line 262. In an embodiment, the piping 261 in the overhead separator level control system 260 and the bypass line 262 may each exhibit a diameter of about 2 inches.

The overhead separator level control system 260 may be operable and otherwise programmed to efficiently control the level of the bottom liquid 246 in the overhead separator 222, which advantageously allows the wastewater processing system 201 to operate using the pressure created by the compressor 220 and otherwise without the need of an additional high pressure compressor (e.g., the second compressor 116 of FIG. 1) in the piping between the overhead separator level control system 260 and the sour water stripper 226, as is commonly required prior art systems, such as those of FIG. 1.

In an embodiment, a plurality of gas drying systems, shown as gas drying systems 200a, 200b, and 200c, will process corresponding wastewater streams that tie into header piping 282 in fluid communication with the downstream systems 224. Similar to the gas drying system 200, each gas drying system 200a-c may include a corresponding glycol-based gas dehydration system 202 and a corresponding glycol regeneration system 204. Accordingly, in the illustrated embodiment, four gas drying systems 200 and 200a-c may be fluidly coupled to the header piping 282 leading to the downstream systems 224. As indicated above, the downstream systems 224 may include one or more water strippers 226 and a condensate sphere 228. As additional gas drying systems 200 and 200a-c are fluidly coupled to the header piping 282, the diameter of the header piping 282 may be increased to account for the increased flow of wastewater. For example, the diameter of the piping 254 exiting the overhead separator level control system 260 may be about 2 inches. If two gas drying systems 200 and one of 200a-c are fluidly coupled to the header piping 282, the diameter of the header piping 282 handling the flow from both gas drying systems 200 may be increased to about 3 inches. If three of four gas drying systems 200 and two or three of 200a-c are fluidly coupled to the header piping 282, the diameter of the header piping 282 handling the flow from all three or four gas drying systems 200 and 200a-c may be increased to about 4 inches.

The wastewater flow from the gas drying systems 200 and 200a-c may be directed to the downstream systems 224 and, more particularly, to the sour water stripper(s) 226 or the condensate sphere 228 through the header piping 282. As the wastewater flow approaches each sour water stripper 226 or the condensate sphere 228, the diameter of the header piping 282 may be able to be decreased. For example, if the diameter of the header piping 282 that accommodates the combined flow from the plurality of gas drying systems 200 and 200a-c is about four inches, the diameter of the piping 284 leading into to each of the plurality of sour water strippers 226 and the condensate sphere 228 may be about 2 inches. The sour water strippers 226 may drain into a large diameter wet hydrocarbon blowdown header 296 via conduits 293 and wet hydrocarbon blowdown line 292. The stripped wastewater from the sour water strippers 226 may be diverted to an evaporation pond through conduit 275, which may include along its path a non-oily wastewater lift station, a pump, and underground piping (not shown). The sour water strippers may also receive sour water from slug catchers via conduit 276.

In one or more embodiments, instead of passing through the sour water strippers 226, the wastewater may be diverted from the header piping 282 or piping 284 to a hydrocarbon recovery drum 290. In an embodiment, wastewater is diverted from the header piping 282 or piping 284 to the hydrocarbon recovery drum 290 by a connecting line 294. In some embodiments, connecting line 294 connects the header piping 282 or piping 284 to the hydrocarbon recovery drum inlet line 295. The connecting line 294 may include a check valve 291 and a car seal opened block valve 297 prior to intersecting the hydrocarbon recovery drum inlet line 295. The hydrocarbon recovery drum inlet line 295 may include a zone valve 283 controlling the flow of liquid into the drum 290. The hydrocarbon recovery drum 290 may also include an outlet overflow line 285 connecting the drum 290 to the large diameter wet hydrocarbon blowdown header 296.

In some embodiments, a bypass line 286 may connect the connecting line 294 to the hydrocarbon outlet overflow line 285. In some embodiments, the bypass line 296 may include a car seal closed block valve 287. This bypass line 296 may be used to divert wastewater directly to a burn pit during periods of time with the hydrocarbon recover drum 290 is out of service, such as for testing an inspections or other maintenance activities without having to stop the glycol dehydration process. In an embodiment, the header piping 282 may exhibit a diameter in a range from about two inches to about four inches, the wet hydrocarbon blowdown line 292 may exhibit a diameter of about three inches, the connecting line 294 may exhibit a diameter of about two inches, the bypass line 286 may exhibit a diameter of about two inches, the hydrocarbon recovery drum inlet line 295 may exhibit a diameter of about ten inches, the outlet overflow line 285 may exhibit a diameter of about four inches, and the wet hydrocarbon blowdown header 296, which is typically used to send wet hydrocarbon liquid to a burn pit, may exhibit a diameter of about 30 inches.

Wastewater may exit the wastewater recovery drum 290 via conduit 288, which may include one or more zone valves 289 (one shown). Wastewater exiting the wastewater recovery drum 290 may pass through one or more high-pressure pumps 298 (one shown), which sends the wastewater to the condensate sphere 228. In an embodiment, the discharge pressure of the high-pressure pump 298 may be about 80 psig with a velocity in a range from about 4.8 ft/s to about 5 ft/s and a maximum flow rate of about 110 gpm. In embodiments, a portion of the wastewater exiting the condensate sphere 228 is diverted to a condensate export line (not shown) via conduit 278. In some embodiments, a portion of the wastewater exiting the condensate sphere 228 is diverted back the sour water strippers 226 via conduit 279.

In one or more embodiments, the pressure generated by the compressor 220 is sufficient to result in the flow of wastewater from the overhead separator 222 to the sour water stripper(s) 226. The pressure may also be sufficient to result in the flow of wastewater from the sour water stripper(s) 226 to the hydrocarbon recovery drum 290. The difference in pressure from the compressor 220 to the sour water stripper(s) 226 may be less than 20 psig, and the erosional flow velocity is about 13 ft/sec. In embodiments, the pressure in the system that is sufficient to operate the sour water strippers(s) 226 may be referred to herein as “system pressure”. In embodiments, the system pressure may be at least about 25 psig and in other embodiments, the system pressure may be at least about 30 psig. In other embodiments, the system pressure may be in a range from about 25 psig to about 60 psig, and in further embodiments, the system pressure may be in a range from about 30 psig to about 50 psig.

In an example of an embodiment of the invention, the pressure generated by the compressor 220 may be in a range from about 45 psig to about 50 psig and velocity may be in a range from about 0.15 ft/s to about 0.5 ft/s. Continuing with this example, the operating pressures in the overhead separator may also be about 45 psig to about 50 psig. In contrast, the pressure in the hydrocarbon recovery drum may be about 1 atm. The maximum flow rate of liquid to the hydrocarbon recovery drum may be about 110 gpm. The condensate sphere operating pressure is in a range from about 25 psig to about 60 psig, and in further embodiments, the condensate sphere operating pressure may be in a range from about 30 psig to about 50 psig.

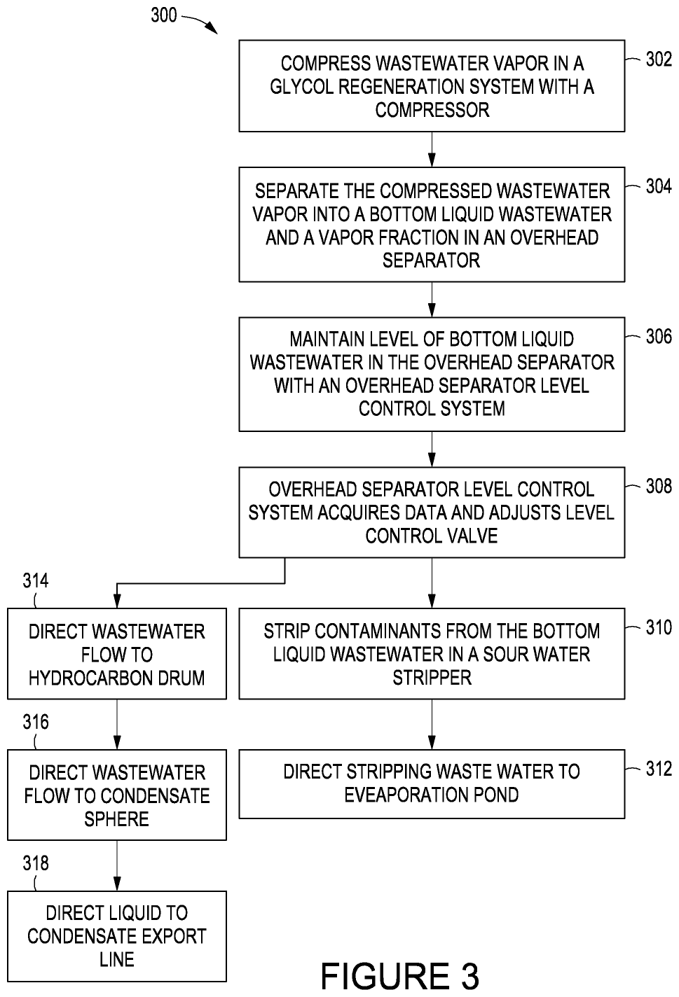

FIG. 3 is a schematic flow chart of an example method 300 of processing wastewater in a glycol regeneration system, in accordance with the embodiments of the present disclosure. The method 300 includes compressing wastewater vapor in a glycol regeneration system with a compressor, as at 302. The compressed wastewater vapor then flows into an overhead separator where it is separated into a bottom liquid and a vapor fraction, as at 304. The level of bottom liquid in the overhead separator is between a low-level operating capacity and a high-level operating capacity using an overhead separator level control system, as at 306. In an embodiment, the overhead separator level control system acquires data about the bottom liquid level in the overhead separator and a LCV controller controls the open and closed state of a level control valve, thereby controlling the flow of bottom liquid wastewater from the overhead separator to downstream systems, such as a sour water stripper, as at 308. After passing through the overhead separator level control system, the method 300 further includes stripping contaminants from the bottom liquid wastewater in a sour water stripper, as at 310, and thereby discharging stripped water. The stripped water may be directed to an evaporation pond, as at 312. In at least one embodiment, one line from the sour water strippers is diverted to the wet hydrocarbon blowdown header, which is mainly the instrumentation drains.

In some embodiments of the method 300, a portion of the wastewater is directed directly to the hydrocarbon drum, bypassing the sour water stripper, as at 314. Liquid exiting the hydrocarbon recovery drum may be directed to a condensate sphere, as at 316. In an embodiment, the liquid exiting the hydrocarbon recovery drum passes through a pump in the piping between the drum and the condensate sphere. Hydrocarbon liquid exiting the condensate sphere may be directed from the condensate sphere to a condensate export line, as at 318. Wastewater exiting the condensate sphere as step 316 may be directed to sour water stripper to strip contaminants, as at 310.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including.” “comprises”, and/or “comprising.” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A wastewater processing system, comprising:
a compressor arranged to receive and compress wastewater vapor into a compressed wastewater;
an overhead separator that receives the compressed wastewater from the compressor and separates the compresses wastewater into bottom liquid wastewater and a vapor fraction;
at least one of a condensate sphere and a sour water stripper, each in fluid communication with the overhead separator, wherein the sour water stripper is configured to receive a portion of the bottom liquid wastewater; and
an overhead separator level control system interposing the overhead separator and the at least one of the condensate sphere and the sour water stripper, the overhead separator level control system being configured to control a flow of the bottom liquid wastewater from the overhead separator to the sour water stripper and maintain a system pressure.

2. The system of claim 1, wherein the overhead separator level control system includes:
a level control valve arranged in piping extending between the overhead separator and the sour water stripper;
a level control valve controller (“LCV controller”); and
instrumentation for acquiring data about a level of the bottom liquid wastewater in the overhead separator.

3. The system of claim 2, wherein the LCV controller receives data from the instrumentation regarding a level of the bottom liquid wastewater and controls open and closed states of the level control valve based on the data.

4. The system of claim 3, wherein the LCV controller directs the level control valve to be in an opened state if the data from the instrumentation indicates the level of bottom liquid wastewater is above a normal level set point.

5. The system of claim 1, wherein the overhead separator level control system maintains a level of the bottom liquid wastewater in the overhead separator in a range between about 25% total volume to about 90% total volume, wherein the total volume is the total volumetric capacity of the overhead separator.

6. The system of claim 1, wherein the compressor is operable to compress the wastewater vapor to a pressure ranging between about 40 psig and about 60 psig.

7. The system of claim 1, wherein the system pressure ranges from about 25 psig to about 60 psig.

8. The system of claim 1, wherein a difference in pressure from the compressor to the sour water stripper is less than or equal to 20 psig.

9. The system of claim 1, further comprising a header piping, a connector line, and a hydrocarbon recovery drum, the header piping fluidly connecting the overhead separator level control system to the hydrocarbon recovery drum via the connector line.

10. The system of claim 9, further comprising a hydrocarbon recovery drum inlet line fluidly connecting the connector line to the hydrocarbon recovery drum.

11. A method, comprising:
compressing wastewater vapor with a compressor and thereby providing a compressed wastewater;
receiving the compressed wastewater in an overhead separator;
separating the compressed wastewater in the overhead separator into a bottom liquid wastewater and a vapor fraction;
maintaining a level of bottom liquid wastewater in the overhead separator between a low-level operating capacity and a high-level operating capacity using an overhead separator level control system; and
stripping contaminants from the bottom liquid wastewater in a sour water stripper.

12. The method of claim 11, wherein the overhead separator level control system includes a level control valve arranged in piping extending between the overhead separator and the sour water stripper and a level control valve controller, and wherein maintaining the level of bottom liquid wastewater in the overhead separator comprises adjusting a position of the level control valve controller.

13. The method of claim 12, wherein the overhead separator level control system further includes instrumentation that monitors a level of the bottom liquid wastewater in the overhead separator, the method further comprising:
acquiring data regarding the level of bottom liquid wastewater in the overhead separator with the instrumentation; and
adjusting the position of the level control valve controller between open and closed states based on a real-time reading of the level of the bottom liquid wastewater obtained by the instrumentation.

14. The method of claim 11, further comprising conveying a portion of the bottom liquid wastewater from the overhead separator to a hydrocarbon recovery drum.

15. The method of claim 14, further comprising conveying the portion of the bottom liquid wastewater from the overhead separator to the hydrocarbon drum via a connecting line.
